(19) United States
(12) Patent Application Publication
(10) Pub. No.: US 2013/0002554 A1
(43) Pub. Date: Jan. 3, 2013

(54) SOLAR-POWERED MOUSE

(75) Inventor: JUI-KUN HSIEH, Tu-Cheng (TW)

(73) Assignee: HON HAI PRECISION INDUSTRY CO., LTD., Tu-Cheng (TW)

(21) Appl. No.: 13/326,229

(22) Filed: Dec. 14, 2011

(30) Foreign Application Priority Data
Jun. 30, 2011 (TW) 100123013

(51) Int. Cl. G06F 3/033

(52) U.S. Cl. 345/163

(57) ABSTRACT

A mouse includes a shell, a solar panel, a dry battery, a rechargeable battery, a power switch element and a circuit board. The dry battery, the rechargeable battery, the power switch element and the circuit board all are positioned in the shell. The solar panel is configured to convert light energy into an electrical voltage to recharge the rechargeable battery. The rechargeable battery and the dry battery are electrically connected to the power switch element. The power switch element is configured to select one of the dry battery and the rechargeable battery to power the circuit board.

### BACKGROUND

1. Technical Field

The disclosure generally relates to mouses and, particularly, to a mouse utilizing a solar panel.

2. Description of Related Art

A computer mouse is in common use. The computer mouse may include a main body and a battery. The battery supplies power for the mouse to function. A rechargeable battery can be charged many times by a charger using an alternating current (AC) power source. Conventional rechargeable batteries include nickel-cadmium (Ni-Cad) batteries, nickel-hydrogen (Ni—H) batteries, lithium ion (Li-ion) batteries, and more. Rechargeable batteries can be recharged again and again.

In general, a particular mouse can only use a corresponding kind of rechargeable battery which can be charged only with a dedicated charger. The rechargeable battery cannot be recharged without the corresponding charger. Accordingly, if the charger is misplaced or broken, the rechargeable battery may not be recharged. In such circumstances, the user is inconvenienced.

What is needed, therefore, is a mouse to overcome the above-described problem.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a perspective view of a mouse utilizing a solar cell in accordance with a first embodiment.

FIG. 2 is an enlarged, schematic cross-section of the solar cell of FIG. 1.

FIG. 3 is a perspective view of a mouse utilizing a solar cell in accordance with a second embodiment.

### DETAILED DESCRIPTION

Embodiments of the disclosure will be described, with reference to the accompanying drawings.

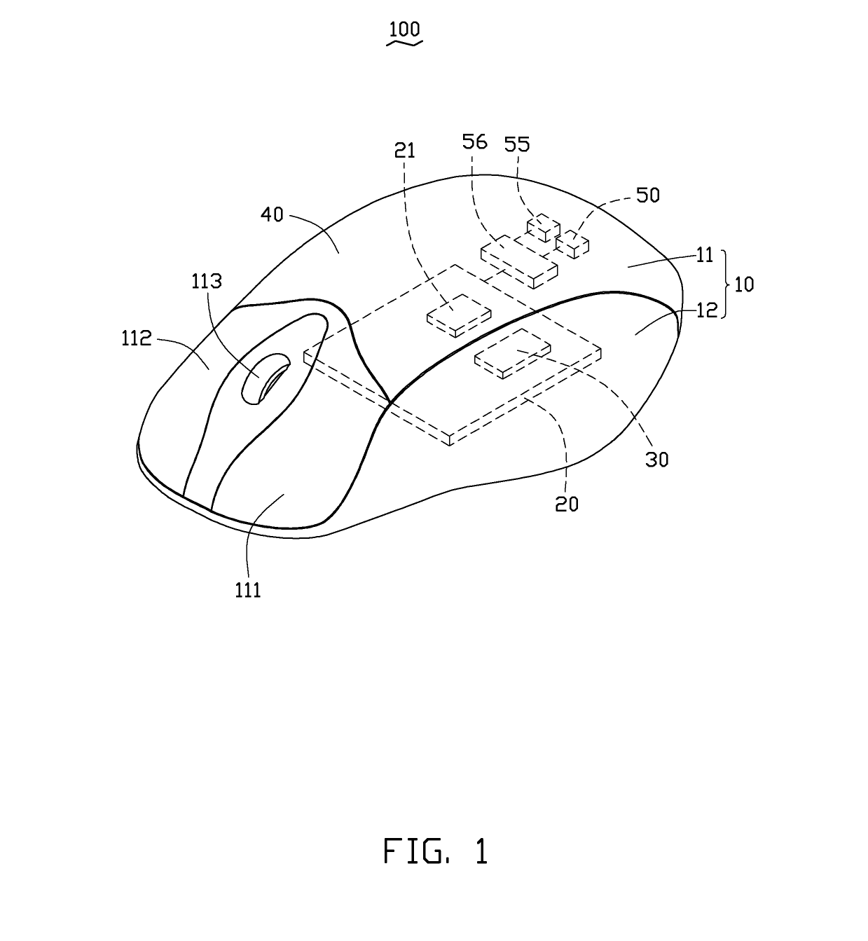

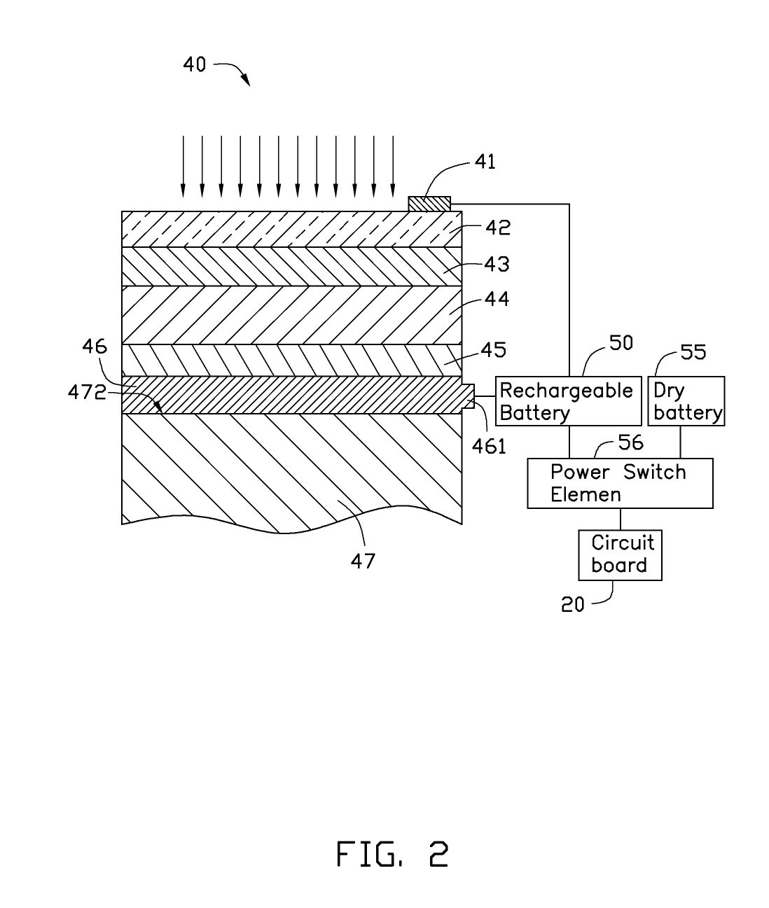

Referring to FIGS. 1-2, a mouse 100 of an embodiment is used for an electronic device (not shown). The mouse 100 includes a shell 10, a circuit board 20, a wireless signal emission chip 30, a solar panel 40, and a rechargeable battery 50. In the embodiment, the electronic device is a computer system. The electronic device can also be a laptop, a personal digital assistant (PDA), or the like.

The shell 10 includes a front cover 11 and a rear cover 12. The front cover 11 and the rear cover 12 are connected with each other to cooperatively receive the circuit board 20, the wireless signal emission chip 30, and the rechargeable battery 50. A left button 111 and a right button 112 are exposed on the front cover 11, and a roller 113 is positioned between the left button 111 and the right button 112.

A detection circuit 21 is mounted on and electrically connected to the circuit board 20. The detection circuit 21 generates signals when the user touches the left button 111 or the right button 112 or the roller 113.

The wireless signal emission chip 30 is electrically mounted on the circuit board 20, and wirelessly transmits the signals generated by the detection circuit 20 to the computer system.

In the embodiment, the solar panel 40 constitutes the front cover 11. The front cover 11 is configured for absorbing sunlight or other ambient light. When the light shines on the front cover 11, the solar panel 40 converts the light into an electrical voltage. The electrical voltage is then stored in the rechargeable battery 50. The rechargeable battery 50 supplies a voltage to components within the mouse 100 to power the functions of the mouse 100.

The solar panel 40 includes a substrate 47 having a first surface 472. A back electrode layer 46 is positioned on the first surface 472 of the substrate 47. A p-type semiconductor layer 45 is positioned on the back electrode layer 46. A p-n junction layer 44 is positioned on the p-type semiconductor layer 45. An n-type semiconductor layer 43 is positioned on the p-n junction layer 44. A transparent conductive layer 42 is positioned on the n-type semiconductor layer 43. A front electrode layer 41 is positioned on the transparent conductive layer 42.

In the embodiment, the substrate 47 is made of a flexible foil of aluminum and magnesium (an Al—Mg alloy). The substrate 47 has a thickness of about 10 μm to about 100 μm. In alternative embodiments, the substrate 47 can also be made of, but is not limited to, Al, Mg, stainless steel, a polymer material, or a mixture.

The back electrode layer 46 can be silver (Ag), copper (Cu), molybdenum (Mo), Al, an alloy of Al and Cu, an alloy of Ag and Cu, or an alloy of Cu and Mo. The back electrode layer 46 includes a connection end 461.

The p-type semiconductor layer 45 can be a p-type amorphous silicon (p-a-Si). In one embodiment, the p-type semiconductor layer 45 is a p-type amorphous silicon with hydrogen (p-a-Si:H). In alternative embodiments, the p-type semiconductor layer 45 can also be, but is not limited to, a compound of the subgroups III-V or a compound of the subgroups II-VI, such as semiconductor material doped with elemental Al, gallium (Ga), or indium (In). The semiconductor material doped with elemental Al, Ga, or In can be aluminum gallium nitride (AlGaN) or aluminum gallium arsenide (AlGaAs).

The p-n junction layer 44 can be one compound of the subgroups III-V and/or of the subgroups I-III-VI, such as CdTe, CuInSe₂, CIGS (CuIn_{1-X}GaSe₂), etc. The p-n junction layer 44 is configured for converting photons to electron-hole pairs, resulting in the creation of an electric field.

The n-type semiconductor layer 43 is an n-type amorphous silicon (n-a-Si) or an n-type amorphous silicon with hydrogen (n-a-Si:H). Alternatively, the n-type semiconductor layer 43 can be one compound of the subgroups III-V or of the subgroups II-VI, such as semiconductor material doped with elemental nitrogen (N), phosphor (P), or arsenic (As). The semiconductor material doped with elemental N, P, or As can be gallium nitride (GaN) or gallium indium phosphide (GaInP).

The transparent conductive layer 42 can be indium tin oxide (ITO) or indium zinc oxide (IZO).

The front electrode layer 41 can be Ag, Cu, Mo, Al, an alloy of Al and Cu, an alloy of Ag and Cu, or an alloy of Cu and Mo.

The rechargeable battery 50 can be a lithium ion battery or a nickel-metal hydride battery. An anode and a cathode of the rechargeable battery 50 are respectively electrically connected to the front electrode layer 41 and the connection end 461 of the back electrode layer 46.

It is to be understood that a solar panel 40 can also constitute the rear cover 12. In such a case, the rear cover 12 is also configured for absorbing sunlight or other ambient light. When the rear cover 12 receives light, the solar panel 40 converts the light into an electrical voltage.

In the embodiment, the mouse 100 also includes a dry battery 55 and a power switch element 56. The dry battery 55 and the rechargeable battery 50 are alternatively connections in the power switch element 56. The power switch element 56 may select an electrical source as being either the dry battery 55 or the rechargeable battery 50.

It is to be understood that in alternative embodiments, the dry battery 55 and the power switch element 56 can be omitted. In such cases, the solar panel 40 is directly connected to the circuit board 20 for supplying a voltage to the circuit board 20 to power the functions of the mouse 100.

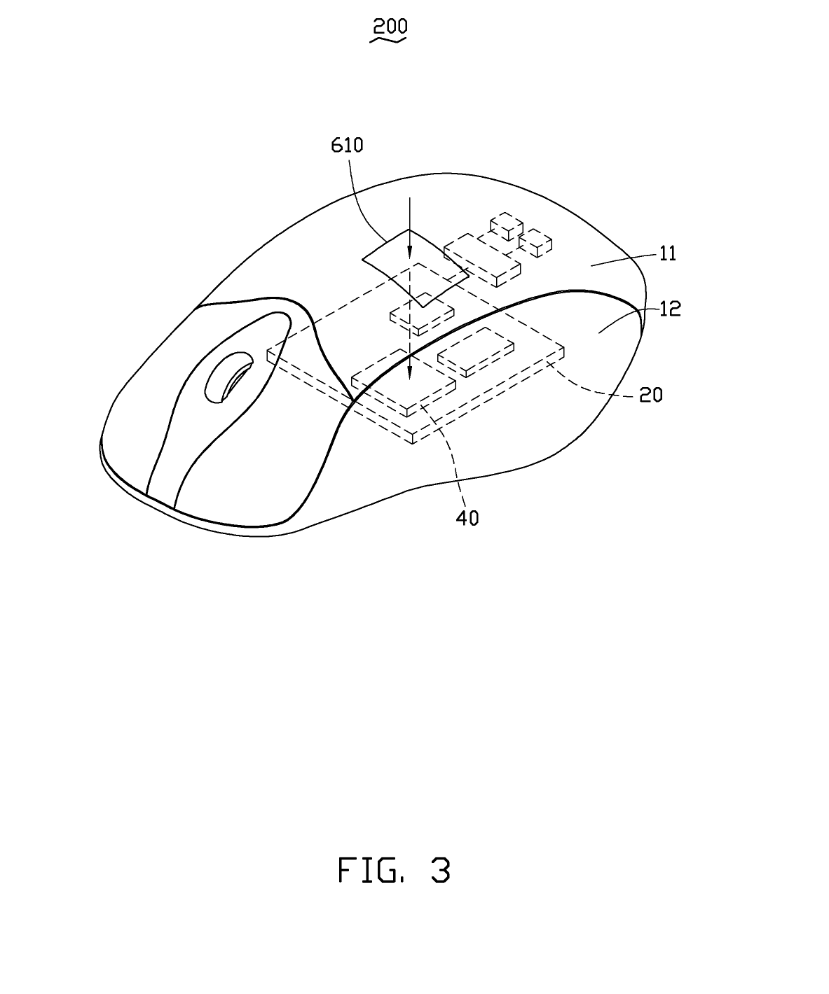

FIG. 3 is a perspective view of a second embodiment of a mouse 200 utilizing a solar panel 40. The mouse 200 differs from the mouse 100 in that a transparent section 610 is formed on the front cover 11. The transparent section 610 is composed of a material, such as transparent resin, polymethyl methacrylate, or polyepoxy compound. The rear cover 12 is composed of an opaque material, such as plastic or metal. The solar panel 40 is mounted on the circuit board 20 so as to be aligned with the transparent section 610. The light passes through the transparent section 610 and shines on the solar panel 40 which converts the light into an electrical voltage.

While certain embodiments have been described and exemplified above, various other embodiments will be apparent to those skilled in the art from the foregoing disclosure. The disclosure is not limited to the particular embodiments described and exemplified, and the embodiments are capable of considerable variation and modification without departure from the scope of the appended claims.

What is claimed is:

1. A mouse comprising:
a shell comprising a front cover and a rear cover, the front cover and the rear cover connected with each other;
a solar panel constituting the front cover, and configured for absorbing sunlight or other ambient light to convert the absorbed light into an electrical voltage;
a dry battery received in the shell;
a rechargeable battery received in the shell, and configured for storing the electrical voltage converted by the solar panel;
a circuit board received in the shell; and
a power switch element received in the shell, both the dry battery and the rechargeable battery electrically connected to the power switch element, the power switch element configured to select an electrical source as being either the dry battery or the rechargeable battery to power the circuit board.

2. The mouse of claim 1, wherein the solar panel comprises a substrate having a first surface, a back electrode layer, a p-type semiconductor layer, a p-n junction layer, an n-type semiconductor layer, a transparent conductive layer, and a front electrode layer, the back electrode layer is positioned on the first surface of the substrate, the p-type semiconductor layer is positioned on the back electrode layer, the p-n junction layer is positioned on the p-type semiconductor layer, the n-type semiconductor layer is positioned on the p-n junction layer, the transparent conductive layer is positioned on the n-type semiconductor layer, and the front electrode layer is positioned on the transparent conductive layer.

3. The mouse of claim 2, wherein the substrate is made of flexible material.

4. The mouse of claim 1, comprising a roller, a left button and a right button, wherein the left button and the right button are exposed on the front cover, and the roller is positioned between the left button and the right button.

5. The mouse of claim 4, comprising a detection circuit mounted on and electrically connected to the circuit board, wherein when a user touches one of the left button, the right button and the roller, the detection circuit is configured to generate a corresponding control signals.

6. The mouse of claim 5, comprising a wireless signal emission chip electrically mounted on the circuit board, wherein the wireless signal emission chip is configured to wirelessly transmit the signals by the detection circuit to a computer system.

7. The mouse of claim 1, comprising another solar panel constituting the rear cover.

8. A mouse comprising:
a shell comprising a front cover and a rear cover, the front cover and the rear cover connected with each other, the shell comprising a transparent section positioned on the front cover;
a circuit board received in the shell;
a solar panel mounted on the circuit board and aligning with the transparent section, the solar panel configured for absorbing sunlight or other ambient light to convert the absorbed light into electrical voltage; and
a rechargeable battery received in the shell and electrically connected with the circuit board and the solar panel, the rechargeable battery being configured for storing the electrical voltage converted by the solar panel to power the circuit board.

9. The mouse of claim 8, wherein the transparent section is composed of a transparent resin.

10. The mouse of claim 8, wherein the transparent section is composed of ploymethyl methacrylate, or polyepoxy compound.

11. The mouse of claim 8, wherein the rear cover is composed of an opaque material.

12. The mouse of claim 8, wherein the solar panel comprises a substrate having a first surface, a back electrode layer, a p-type semiconductor layer, a p-n junction layer, an n-type semiconductor layer, a transparent conductive layer, and a front electrode layer, the back electrode layer is positioned on the first surface of the substrate, the p-type semiconductor layer is positioned on the back electrode layer, the p-n junction layer is positioned on the p-type semiconductor layer, the n-type semiconductor layer is positioned on the p-n junction layer, the transparent conductive layer is positioned on the n-type semiconductor layer, and the front electrode layer is positioned on the transparent conductive layer.

13. The mouse of claim 12, wherein the substrate is made of flexible material.

14. The mouse of claim 8, comprising a roller, a left button and a right button, the left button and right button being exposed on the front cover, and the roller being positioned between the left button and the right button.

15. The mouse of claim 14, comprising a detection circuit mounted on and electrically connected to the circuit board, wherein when a user touches one of the left button, the right button and the roller, the detection circuit is configured to generate a corresponding control signals.

16. The mouse of claim 15, comprising a wireless signal emission chip electrically mounted on the circuit board and configured to wirelessly transmit the signals by the detection circuit to a computer system.
